(19) United States
(12) Patent Application Publication
(10) Pub. No.: US 2017/0266989 A1
(43) Pub. Date: Sep. 21, 2017

(54) CONVEYING DEVICE AND PRINTING APPARATUS

(71) Applicants: Masato OGAWA, Kanagawa (JP); Kohki ASADA, Tokyo (JP); Natsuki SUGIYAMA, Kanagawa (JP)

(72) Inventors: Masato OGAWA, Kanagawa (JP); Kohki ASADA, Tokyo (JP); Natsuki SUGIYAMA, Kanagawa (JP)

(21) Appl. No.: 15/460,613

(22) Filed: Mar. 16, 2017

(30) Foreign Application Priority Data
Mar. 18, 2016 (JP) 2016-054871
Jan. 10, 2017 (JP) 2017-001574

(51) Int. Cl. B41J 11/00

(52) U.S. Cl. CPC B41J 11/002; B41J 11/007

(57) ABSTRACT

A conveying device includes a restrictor disposed at a predetermined distance from a surface of a sheet material conveyed along a sheet-material conveyance path. The restrictor includes a sheet-material opposing portion that opposes the sheet-material conveyance path. The sheet-material opposing portion is movable to a downstream side in a sheet-material conveyance direction.

### CROSS-REFERENCE TO RELATED APPLICATIONS

This patent application is based on and claims priority pursuant to 35 U.S.C. §119(a) to Japanese Patent Application Nos. 2016-054871, filed on Mar. 18, 2016, and 2017-001574, filed on Jan. 10, 2017, in the Japan Patent Office, the entire disclosure of each of which is hereby incorporated by reference herein.

### BACKGROUND

Technical Field

Embodiments of the present disclosure relate to a conveying device and a printing apparatus.

Related Art

A printing apparatus, such as an inkjet recording apparatus, is known that includes a conveying device to convey sheets.

For example, an inkjet recording apparatus is known that includes a conveying device with a drying device to dry ink attached to a sheet.

### SUMMARY

In an aspect of the present disclosure, there is provided a conveying device that includes a restrictor disposed at a predetermined distance from a surface of a sheet material conveyed along a sheet-material conveyance path. The restrictor includes a sheet-material opposing portion that opposes the sheet-material conveyance path. The sheet-material opposing portion is movable to a downstream side in a sheet-material conveyance direction.

In another aspect of the present disclosure, there is provided a printing apparatus that includes a liquid discharger to discharge liquid to the sheet material and the conveying device to convey the sheet material.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a schematic view of a configuration of an inkjet recording apparatus according to an embodiment of the present disclosure;

FIG. 2 is a front view of a drying unit of the inkjet recording apparatus of FIG. 1;

FIG. 3 is a cross-sectional view of the drying unit cut along a plane perpendicular to a sheet conveyance direction;

FIG. 4 is a top view illustrating a position of a restriction wire adjusted to convey a sheet having a width of 297 mm;

FIG. 5 is a top view illustrating a position of the restriction wire adjusted to convey a sheet having a width of 750 mm;

FIG. 6 is an illustration of a state in which air from a blowing fan hits a surface of a conveyance belt in a blowing region and an air flow is generated toward a leading end of a sheet entering the blowing region from an upstream side in the sheet conveyance direction;

FIG. 7 is an illustration of a state in which air from the blowing fan hits the surface of the conveyance belt in the blowing region and an air flow is generated toward a trailing end of a sheet passing through the blowing region;

FIG. 8 is a front view of the drying unit in Variation 1;

FIG. 9 is a cross-sectional view of the drying unit in Variation 1 cut along a plane perpendicular to the sheet conveyance direction;

FIG. 10 is a front view of an example of the drying unit in Variation 2; and

FIG. 11 is an illustration of a part of an application device as a pre-processing unit in Variation 3.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Hereinafter, embodiments of the present disclosure are described with reference to the drawings.

Overall Description

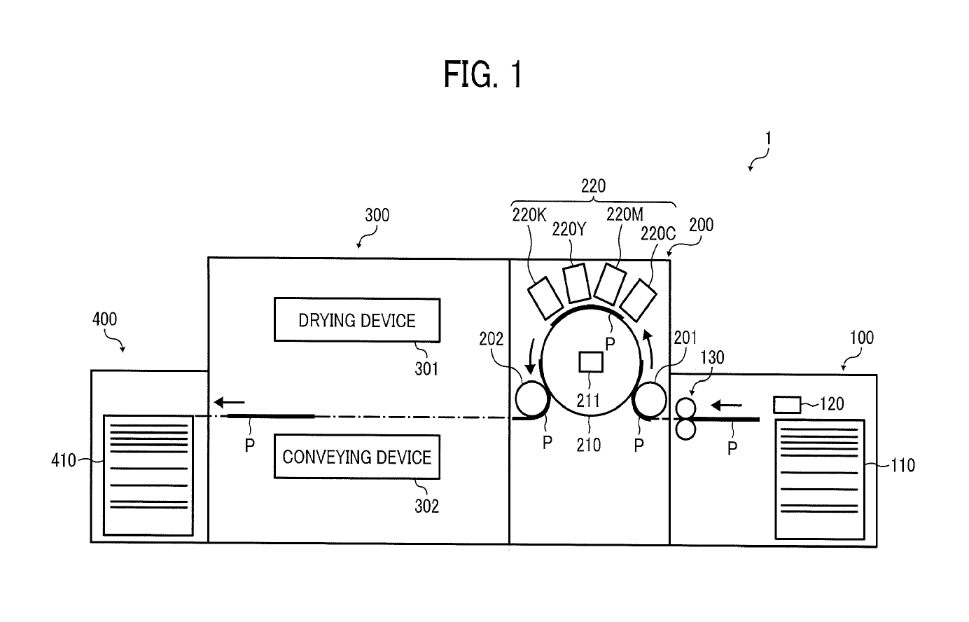

FIG. 1 is a schematic view of a configuration of an inkjet recording apparatus according to an embodiment of the present disclosure. An inkjet recording apparatus 1 according to the present embodiment includes, for example, a sheet feeding unit 100, an image forming unit 200, a drying unit 300, and a sheet ejection unit 400. In the inkjet recording apparatus 1, an image is formed on the sheet P, which is a recording material as a sheet material fed from the sheet feeding unit 100, with ink that is a liquid for image formation in the image forming unit 200. After the ink adhered to the sheet is dried in the drying unit 300, the sheet is ejected from the sheet ejection unit 400.

Sheet Feeding Unit

The sheet feeding unit 100 includes a sheet feed tray 110 on which a plurality of sheets P is stacked, a sheet feeder 120 to separate and feed the sheets P one by one from the sheet feed tray 110, and paired registration rollers 130 to send the sheet P to the image forming unit 200. As the sheet feeder 120, any sheet feeder, such as a device using rollers or a device using air suction, can be used. After the leading end of the sheet fed from the sheet feed tray 110 by the sheet feeder 120 reaches the paired registration rollers 130, the paired registration rollers 130 are driven at a predetermined timing to feed the sheet to the image forming unit 200. In the present embodiment, the sheet feeding unit 100 is not limited to the above-described configuration and may be any other configuration capable of sending the sheet P to the image forming unit 200.

Image Forming Unit

The image forming unit 200 includes, for example, a transfer cylinder 201 to receive the fed sheet P and transfer the fed sheet P to a sheet bearing drum 210, a sheet bearing drum 210 to bear and convey the sheet P conveyed by the transfer cylinder 201 on an outer circumferential surface of the sheet bearing drum 210, an ink discharge unit 220 to discharge ink toward the sheet P borne on the sheet bearing drum 210, and a transfer cylinder 202 to transfer the sheet P conveyed by the sheet bearing drum 210 to the drying unit 300.

The leading end of the sheet P conveyed from the sheet feeding unit 100 to the image forming unit 200 is gripped by a sheet gripper provided on the surface of the transfer cylinder 201 and conveyed with the movement of the surface of the transfer cylinder 201. The sheet conveyed by the transfer cylinder 201 is delivered to the sheet bearing drum 210 at a position facing the sheet bearing drum 210.

The sheet gripper is also provided on the surface of the sheet bearing drum 210, and the leading end of the sheet is gripped by the sheet gripper. A plurality of suction holes are dispersedly formed on the surface of the sheet bearing drum 210, and a sucked air flow directed toward the inside of the sheet bearing drum 210 is generated in each suction hole by a suction device 211. The leading end of the sheet P delivered from the transfer cylinder 201 to the sheet bearing drum 210 is gripped by the sheet gripper, and the sheet is attracted to the surface of the sheet bearing drum 210 by the suction air flow and is conveyed with the movement of the surface of the sheet bearing drum 210.

The ink discharge unit 220 according to the present embodiment discharges inks of four colors of C (cyan), M (magenta), Y (yellow), and K (black) to form an image, and includes individual liquid discharge heads 220C, 220M, 220Y and 220K for respective inks. The configurations of the liquid discharge heads 220C, 220M, 220Y, and 220K are not limited to the above-described configurations and may be any other suitable configurations. For example, a liquid discharge head to discharge special ink, such as white, gold, and silver, may be provided, or a liquid discharge head to discharge a liquid that does not constitute an image, such as a surface coating liquid, may be provided.

The discharge operation of the liquid discharge heads 220C, 220M, 220Y, and 220K of the ink discharge unit 220 is controlled by drive signals corresponding to image information. When the sheet P borne on the sheet bearing drum 210 passes through a region opposed to the ink discharge unit 220, ink of respective colors is discharged from the liquid discharge heads 220C, 220M, 220Y, and 220K to form an image in accordance with the image information. In the present embodiment, the image forming unit 200 is not limited to the above-described configuration and may be any other configuration of forming an image by causing liquid to adhere onto the sheet P.

Drying Unit

The drying unit 300 includes, for example, a drying device 301 to dry the ink adhered onto the sheet P by the image forming unit 200, and a conveying device 302 to convey the sheet P conveyed from the image forming unit 200. After the sheet P conveyed from the image forming unit 200 is received by the conveying device 302, the sheet is conveyed to pass through the drying device 301 and delivered to the sheet ejection unit 400. When passing through the drying device 301, the ink on the sheet P is subjected to a drying process. Thus, the liquid content, such as moisture, in the ink evaporates, the ink is fixed on the sheet P, and the curl of the sheet P is reduced.

Sheet Ejection Unit

The sheet ejection unit 400 includes, for example, a sheet ejection tray 410 on which a plurality of sheet P is stacked. The sheet P conveyed from the drying unit 300 is sequentially stacked and held on the sheet ejection tray 410. In the present embodiment, the configuration of the sheet ejection unit 400 is not limited to the above-described configuration and may be any other configuration capable of ejecting the sheet P.

Other Functional Units

The inkjet recording apparatus 1 according to the present embodiment includes the sheet feeding unit 100, the image forming unit 200, the drying unit 300, and the sheet ejection unit 400. In addition, other functional units may be suitably added. For example, a pre-processing unit to perform pre-processing of image formation can be added between the sheet feeding unit 100 and the image forming unit 200, or a post-processing unit to perform post-processing of image formation can be added between the drying unit 300 and the sheet ejection unit 400.

As the pre-processing unit, for example, there is a unit to perform a treatment liquid application process of applying a treatment liquid for reacting with ink to reduce bleeding to the sheet P. However, the content of the pre-processing is not particularly limited to any specific content. In addition, as the post-processing unit, for example, there is a sheet reverse conveyance processing with the image formed by the image forming unit 200 and sending the sheet to the image forming unit 200 again to form images on both sides of the sheet, or a process for binding a plurality of sheets on which the image is formed, and the like. However, the content of the post-processing is also not particularly limited to any specific content.

In the present embodiment, the printing apparatus is described as an example of an inkjet recording apparatus. However, the “printing apparatus” is not limited to an apparatus that includes a liquid discharge head to discharge liquid toward a surface to be dried of the sheet material, and to make visible significant images, such as letters and graphics, with the discharged liquid. For example, the “printing apparatus” may also be an apparatus to form patterns and the like which have no meaning. The material of the sheet material is not limited, and any sheet material, such as paper, thread, fiber, cloth, leather, metal, plastic, glass, wood, and ceramics, to which liquid can temporarily adhere may be used. For example, sheet materials used for film products, cloth products, such as clothing products, building materials, such as a wall sheet or flooring materials, leather products, and the like may be used. The “printing apparatus” can also include units relating to feeding, conveying, and ejection of a sheet to which liquid can adhere, a pre-processing device, a post-processing device and the like. Further, the term “liquid” includes any liquid having a viscosity or a surface tension that can be discharged from the head. The “liquid” is not limited to a particular liquid and may be any liquid having a viscosity or a surface tension to be discharged from a head. However, preferably, the viscosity of the liquid is not greater than 30 mPa·s under ordinary temperature and ordinary pressure or by heating or cooling. More specifically, the “liquid” is, for example, solution, suspension, emulsion or the like that includes a solvent, such as water or an organic solvent, a colorant, such as a dye or a pigment, a functionalizing material, such as a polymerizable compound, a resin, or a surfactant, a biocompatible material, such as DNA, amino acid, protein, or calcium, edible materials, such as natural pigments, and the like. Such liquids can be used, for example, for inkjet inks, surface treatment liquids and the like. Although there is an apparatus in which the liquid discharge head and the sheet material relatively move as the “printing apparatus”, embodiments of the present disclosure are not limited to such an apparatus. The “printing apparatus” may be, for example, a serial-type apparatus to move a liquid discharge head relative to a sheet material or a line-type apparatus that does not move a liquid discharge head relative to a sheet material.

Further, the term “liquid discharge head” represents a functional component to discharge and jet liquid from discharge orifices (nozzles). As an energy generating source to discharge liquid, for example, a thermal actuator using an electrothermal transducer element, such as a piezoelectric actuator (lamination-type piezoelectric element and thin-film piezoelectric element) and a heat generation resistor, or a discharge energy generator, such as an electrostatic actuator, including a diaphragm plate and opposed electrodes can be used. However, the energy generating source is not limited to any specific type and may be any other suitable discharge energy generator.

Details of Drying Unit

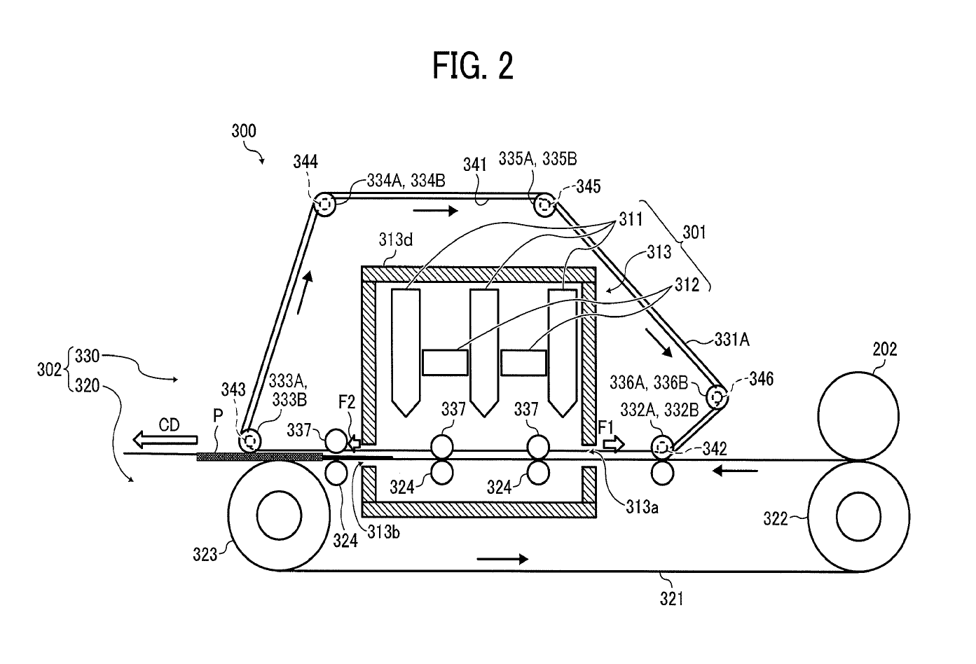

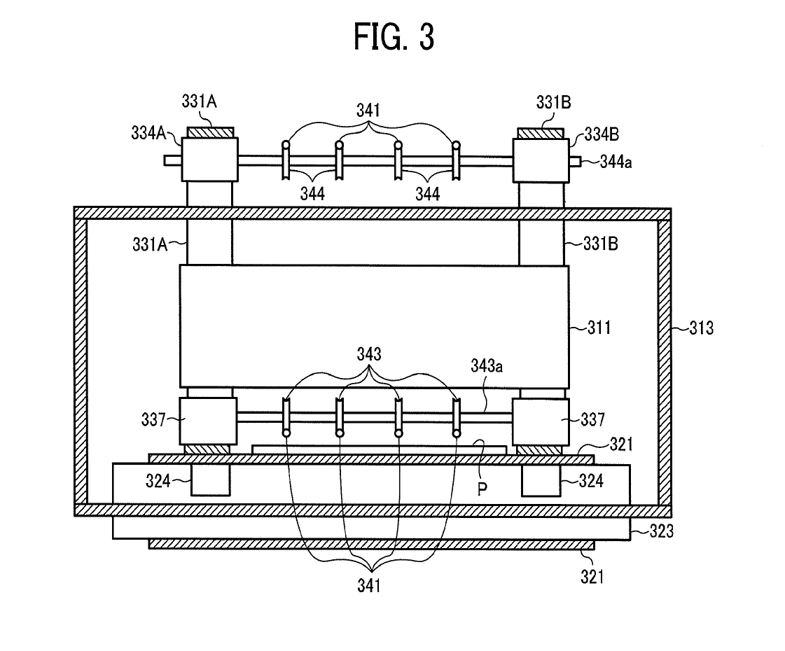

Next, the drying unit 300 in the present embodiment is further described below. FIG. 2 is a front view of the drying unit 300 in the present embodiment. FIG. 3 is a cross-sectional view of the drying unit 300 in the present embodiment, cut along a plane perpendicular to the sheet conveyance direction.

The drying device 301 in the drying unit 300 in the present embodiment includes, for example, a blowing fan 311 to blow air toward the sheet P conveyed by the conveying device 302, a heat generator 312, and a drying chamber 313 formed by surrounding the periphery of the blowing region blown by the blowing fan 311 with a wall member 313d. At least a part of the wall member 313d of the drying chamber 313 is formed of a heat insulating material so that the internal temperature of the drying chamber 313 is not easily lowered. In the drying device 301, the ink on the image surface of the sheet P is dried by the radiant heat of the heat generator 312 and the air blown by the blowing fan 311 with respect to the image surface of the sheet P conveyed to the internal space of the drying chamber 313.

In the drying device 301 of the present embodiment, a plurality of (three in the present embodiment) blowing fans 311 is disposed side by side in the sheet conveyance direction. However, the number and arrangement of the plurality of blowing fans 311 are not limited to the present embodiment and may be any other suitable number and arrangement. In the drying device 301 of the present embodiment, a plurality of (three in the present embodiment) heat generators 312 are disposed side by side in the sheet conveyance direction CD. However, the number and arrangement of the heat generator 312 are not limited to the present embodiment and may be any other suitable number and arrangement. As the heat generator 312, for example, a radiation heater, such as an infrared heater, to radiate infrared rays, and a halogen lump can be used.

The conveying device 302 of the present embodiment includes, for example, a belt conveyor 320 and a sheet restriction assembly 330. The belt conveyor 320 bears the sheet P on the surface of the endless conveyance belt 321 stretched between the two support rollers 322 and 323, and conveys the sheet P in accordance with the movement of the surface of the conveyance belt 321. The length of the conveyance belt 321 in a direction (width direction) perpendicular to the sheet conveyance direction is set to be equal to or greater than the length of the conveyed sheet Pin the width direction. The sheet restriction assembly 330 restricts the sheet P borne on the surface of the conveyance belt 321 from entering the heat generator 312 of the drying device 301 and reduces a conveyance failure that may be generated when the sheet P floats from the surface of the conveyance belt 321.

The conveyance belt 321 mainly travels in the direction of the arrow in the FIG. 1 by movement of at least one of the two support rollers 322 and 323, and the surface moves. Metal, rubber, or the like can be used as the material of the conveyance belt 321, and the material is not particularly limited. However, in the present embodiment, it is preferable to use a heat-resistant material (heat-resistant rubber, metal, or the like) in consideration of being exposed to a high temperature when passing through the inside of the drying chamber 313.

An upstream portion of the conveyance belt 321 in the sheet conveyance direction (a belt portion wound around the first support roller 322) is disposed to face the transfer cylinder 202 of the image forming unit 200. The sheet P conveyed by the transfer cylinder 202 is delivered to the conveyance belt 321 in such a manner that a back side of the image surface faces a front side of the conveyance belt 321, and the sheet P is borne on the surface of the conveyance belt 321. The sheet P borne on the surface of the conveyance belt 321 is conveyed to the side of the second support roller 323 with the movement of the surface of the conveyance belt 321.

The sheet P is mainly held on the surface of the conveyance belt 321 by the action of electrostatic force or frictional force, and the conveyance belt 321 in the present embodiment does not have a mechanism, such as a sheet gripper, but the sheet P may be held on the surface of the conveyance belt 321 by the sheet gripper or the like.

A belt portion (a belt portion that moves from the first support roller 322 to the second support roller 323) that bears the sheet on the conveyance belt 321 is disposed to pass through the inside of the drying chamber 313 of the drying device 301. Accordingly, the sheet P borne on the surface of the conveyance belt 321 passes through the inside of the drying chamber 313 of the drying device 301 with the movement of the surface of the conveyance belt 321. After that, the sheet P is separated from the surface of the conveyance belt 321, and is delivered to the sheet ejection unit 400 via a guide plate, a conveyance roller, or the like.

Sheet Floating Restriction inside Drying Chamber

The sheet restriction assembly 330 according to the present embodiment includes a plurality of restriction wires 341 arranged in a sheet width direction at a predetermined distance from the surface of the belt portion that bears the sheet on the conveyance belt 321 across the sheet conveyance direction of the drying area facing the heat generator 312 (in the present embodiment, across the sheet conveyance direction inside the drying chamber 313). Each restriction wire 341 is looped around five pulleys 342, 343, 344, 345, and 346. When a part of the sheet P such as a leading end or a trailing end of the sheet P borne on the conveyance belt 321 floats, the floating portion of the sheet comes into contact with the sheet opposing portion of the restriction wire 341 (a part of the wire moving from the first pulley 342 to the second pulley 343). As a result, even when a part of the sheet P borne on the conveyance belt 321 floats, this sheet portion is restricted to enter the heat generator 312 side of the drying device 301.

As a part of the sheet floats further, a contact area between the sheet P and the surface of the conveyance belt 321 is reduced. This may make it difficult to appropriately 2 5 convey the sheet along the surface movement of the conveyance belt 321 and may generate a conveyance failure. According to the present embodiment, when a part of the sheet P borne on the conveyance belt 321 floats, the floating sheet portion comes into contact with the restriction wire 341. Therefore, further floating is restricted. As a result, it is possible to suppress reduction of the contact area between the sheet P and the surface of the conveyance belt 321 and implement stable conveyance of the sheet along the surface movement of the conveyance belt 321.

According to the present embodiment, inside the drying chamber 313, the sheet P is pressed to the surface of the conveyance belt 321 by virtue of the air blowing from the blowing fan 311. Therefore, in the blowing area where the air blows from the blowing fan 311, a leading or trailing end of the sheet P does not easily float. However, in particular, if a plurality of blowing fans 311 are arranged in the sheet conveyance direction as in the present embodiment, the sheet P may float in the drying chamber 313 due to the air flow from the blowing fan 311 disposed in the downstream side of the sheet conveyance direction. If floating of the sheet P is generated in the drying chamber 313, and the sheet P remains in the drying chamber 313, removal of the sheet P suffering from the conveyance failure from the inside of the drying chamber 313 is not easy because the inside of the drying chamber 313 has a small opening. Therefore, as far as possible, it is desirable to avoid an occurrence of conveyance failure inside the drying chamber 313.

The restriction wire 341 may be formed of metal, rubber, and the like without a particular limitation. However, it is preferable to use a heat-resistant material (heat resistant rubber, metal, or the like) in consideration of being exposed to a high temperature when passing through the inside of the drying chamber 313. In addition, the restriction wire 341 according to the present embodiment is a metal wire having a diameter of approximately 1 mm. However, embodiments of the present disclosure are not limited to such a metal wire.

Here, the restriction wire 341 is disposed to face the image surface of the sheet P. Therefore, if a leading or trailing end of the sheet P partially floats, an image surface of this floating sheet portion may come into contact with the restriction wire 341. For this reason, undried ink (image) attached on the image surface of the sheet P may be blurred by the contact with the restriction wire 341.

In this regard, according to the present embodiment, the image surface of the floating sheet portion partially (a part of the sheet width direction) comes into contact with the restriction wire 341 which is a long linear member extending along the sheet conveyance direction. As a result, compared to a case where the sheet-material floating restrictor comes into contact with the entire image surface of the floating sheet portion (across the entire sheet width direction), a portion where the undried ink is blurred on the image surface of the floating sheet portion is reduced. Therefore, blurring of ink (image) is suppressed.

Furthermore, according to the present embodiment, the sheet opposing portion of the restriction wire 341 moves to the downstream side in the sheet conveyance direction. As a result, a velocity difference between a surface movement velocity of the image surface of the floating sheet portion coming into contact with the restriction wire 341 and a surface movement velocity of the restriction wire 341 can be reduced or set to zero, compared to a case where the restriction wire 341 is fixed. As a result, rubbing between the undried ink attached on the image surface in the floating sheet portion and the restriction wire 341 is suppressed, and blurring of the undried ink (image) is suppressed.

As a driver of the restriction wire 341, for example, a dedicated drive motor for driving the restriction wire 341 may be used to rotatably drive several pulleys 342, 343, 344, 345, and 346. According to the present embodiment, different drivers are employed to drive the pulleys 342, 343, 344, 345, and 346. Specifically, on the shafts (e.g., shafts 343a and 344a in FIG. 3) of five pulleys 342, 343, 344, 345, and 346 where each restriction wire 341 is looped, five support rollers 332A, 333A, 334A, 335A, 336A, 332B, 333B, 334B, 335B, and 336B are provided in both ends of the axial direction of each pulley. Two drive belts 331A and 331B are looped around these support rollers such that they come into contact with the surface of the conveyance belt 321.

According to the present embodiment, three pressing rollers 337 are provided in each inner circumferential surface of the belt portion where the drive belts 331A and 331B abut on the conveyance belt 321. A back-up roller 324 is provided on the inner circumferential face side of the conveyance belt 321 of the belt conveyor 320 at positions facing the pressing rollers 337 and the first support rollers 332A, 332B. As a result, the drive belts 331A and 331B abut on the surface of the conveyance belt 321 with a sufficient pressure, and the drive belts 331A and 331B can be rotated to follow the conveyance belt 321.

If the conveyance belt 321 is driven to make a surface movement, a pair of drive belts 331A and 331B abutting on the surface of the conveyance belt 321 are rotated to follow the movement of the conveyance belt 321. As a result, each support roller 332A, 333A, 334A, 335A, 336A, 332B, 333B, 334B, 335B, and 336B where the drive belts 331A and 331B are looped is rotated. As a result, the restriction wire 341 is rotated to follow the movement of the conveyance belt 321, and the sheet opposing portion of the restriction wire 341 moves to the downstream side of the sheet conveyance direction.

If such a driver of the restriction wire 341 is employed, a dedicated drive motor for the restriction wire 341 is not necessary. In addition, the sheet opposing portion of the restriction wire 341 can easily move at the same velocity as the velocity of the surface of the conveyance belt 321. Since the sheet opposing portion of the restriction wire 341 moves at the same velocity as the velocity of the surface of the conveyance belt 321, a velocity difference between the movement velocity of the sheet opposing portion of the restriction wire 341 and the movement velocity of the image surface of the sheet borne and conveyed on the surface of the conveyance belt 321 substantially becomes zero. As a result, rubbing is not generated even when the undried ink attached on the image surface of the floating sheet portion comes into contact with the restriction wire 341. In addition, blurring (scrape) of the undried ink (image) is suppressed.

Although the sheet opposing portion of the restriction wire 341 moves at the same velocity as the velocity of the surface of the conveyance belt 321 according to the present embodiment, any other configuration may be employed as long as the sheet opposing portion of the restriction wire 341 moves such that a relative velocity difference between the sheet opposing portion of the restriction wire 341 and the surface of the conveyance belt 321 is smaller than the relative velocity difference when the restriction wire is fixed (that is, the surface movement velocity of the conveyance belt 321). In this configuration, compared to a case where the restriction wire is fixed, rubbing of the restriction wire 341 to the undried ink is suppressed, and blurring (scrape) of the ink can be sufficiently suppressed.

The drive belts 331A and 331B may be formed of metal or rubber without any particular limitation. However, it is preferable to use a heat-resistant material (heat resistant rubber, metal, or the like) in consideration of being exposed to a high temperature when passing through the inside of the drying chamber 313.

A distance between the surface of the conveyance belt 321 and the restriction wire 341 is appropriately set. According to the present embodiment, this distance is set to be equal to or longer than 1 mm and equal to or shorter than 5 mm. According to the present embodiment, as illustrated in FIG. 2, outer diameters of the five pulleys 342, 343, 344, 345, and 346 where the restriction wire 341 is looped is smaller than outer diameters of the five support rollers where the drive belts 331A and 331B are looped. As a result, by setting this difference of the outer diameters, it is possible to set the distance between the surface of the conveyance belt 321 and the restriction wire 341.

According to the present embodiment, each restriction wire 341 is displaceable in the sheet width direction along with the five pulleys 342, 343, 344, 345, and 346 where the restriction wire 341 is looped. As a result, it is possible to adjust a relative opposing position of the restriction wire 341 against the sheet P or the number of restriction wires 341 opposing the sheet P. In addition, it is possible to position the restriction wire 341 to appropriately face the sheets having different widths or position an appropriate number of restriction wires. Note that the restriction wire 341 may be displaced in the sheet width direction manually by a user or using a driver.

If the positions of the restriction wires 341 are adjusted to face only both end regions of the width direction on the image surface of the sheet P, the restriction wire 341 does not come into contact in the center area of the width direction on the image surface of the sheet P even when the floating sheet portion comes into contact with the restriction wire 341. Therefore, it is possible to restrict floating. If the position is adjusted in this manner, both end regions of the width direction on the image surface of the sheet P are less influenced by blurring than the center region of the width direction. Therefore, inconvenience caused by blurring of the ink (image) can be reduced. In particular, if positions of the restriction wires 341 are adjusted to face only the marginal region (non-image region) of the width direction on the image surface of the sheet P, it is possible to restrict floating without a contact between the restriction wire 341 and the image region in the center of the width direction on the image surface of the sheet P. Therefore, it is possible to effectively suppress blurring of the ink (image).

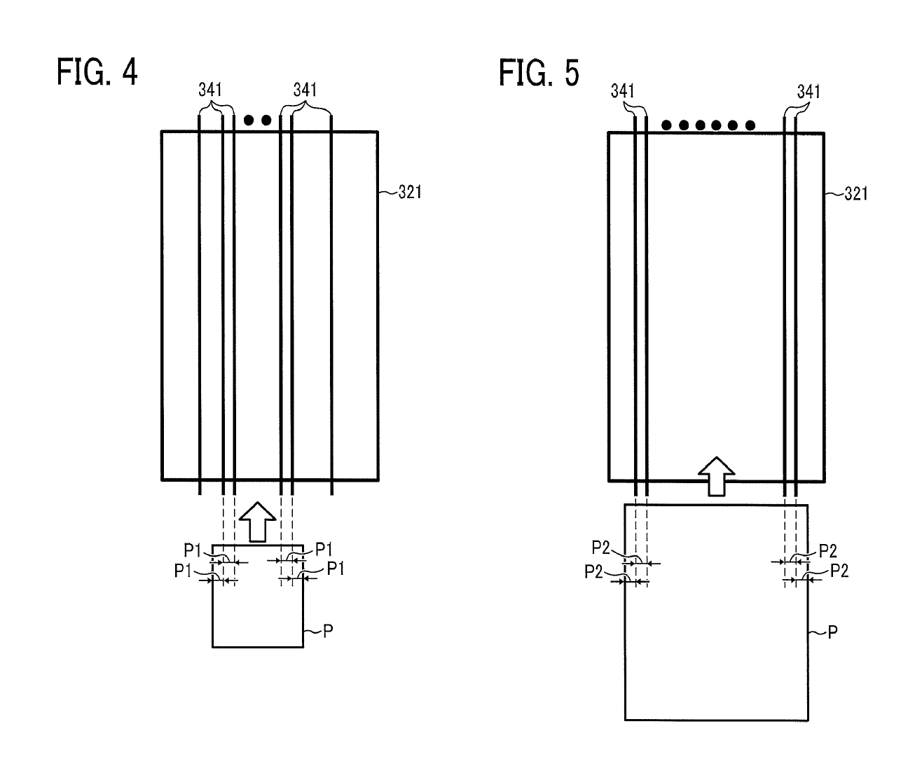

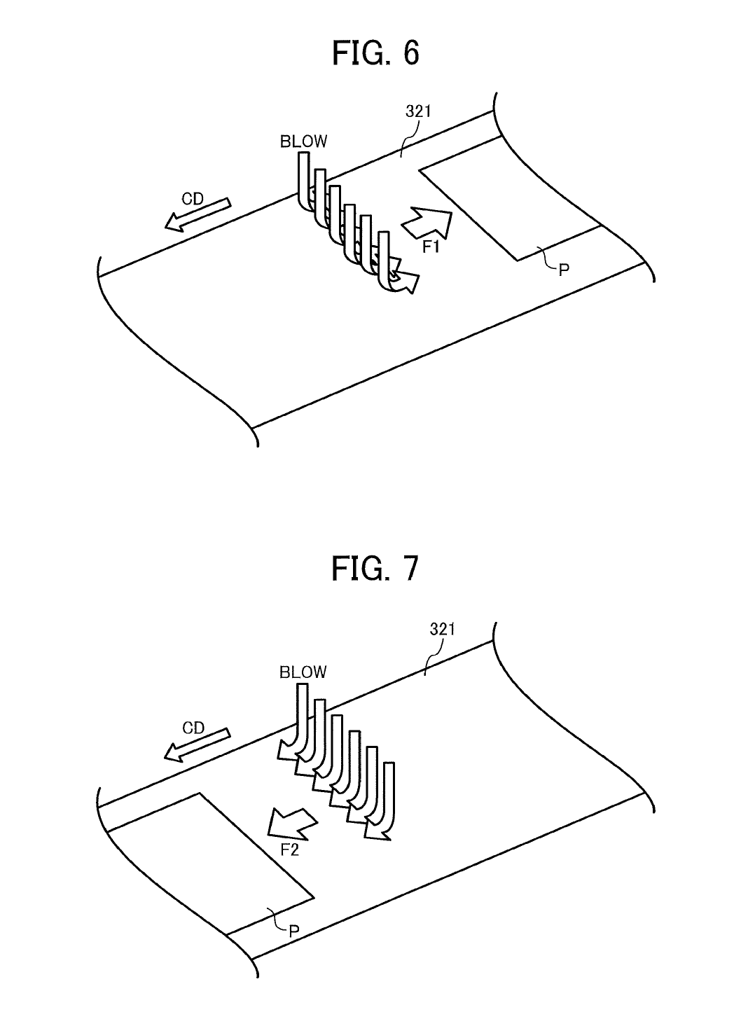

Specifically, for example, as illustrated in FIG. 4, for a sheet having a width of 297 mm, two restriction wires 341 are positioned to face each end region of the width direction at a pitch P1 of 10 mm. Meanwhile, for example, as illustrated in FIG. 5, for a sheet having a width of 750 mm, two restriction wires 341 are positioned to face both end regions of the width direction at a pitch P2 of 20 mm.

According to the present embodiment, a thin restriction wire 341 is employed as the sheet-material floating restrictor for restricting the floating by partially making contact with the image surface of the floating sheet portion. Therefore, a contact between the floating sheet portion and the image surface roughly becomes a line contact. Due to such a line contact, it is possible to restrict the floating sheet portion by significantly reducing a contact area between the image surface of the floating sheet portion and the sheet-material floating restrictor.

Note that the sheet-material floating restrictor is not limited to such a restriction wire 341. Instead, any configuration may be employed as long as restriction can be obtained by partially making contact with the image surface of the floating sheet portion. Therefore, a belt member having an embossed surface or a mesh-like belt member may be employed as the sheet-material floating restrictor. In addition, such a belt member may be disposed to face the image surface of the sheet P borne and conveyed on the conveyance belt 321. As a belt member having an embossed surface, for example, a belt having a surface where a plurality of acute protrusions are distributed may be employed. In this case, the contact between the floating sheet portion and the image surface roughly becomes a point contact. Therefore, it is possible to restrict the floating sheet portion by remarkably reducing the contact area between the image surface of the floating sheet portion and the sheet-material floating restrictor.

Floating Restriction in Leading End of Sheet

According to the present embodiment, the sheet P borne on the surface of the conveyance belt 321 receives the air blowing from the blowing fan 311 in a direction normal to the image surface (blowing target surface) of the sheet P when it passes through the inside of the drying chamber 313 of the drying device 301. In this case, before the sheet P enters the blowing area of the blowing fan 311, the air blowing from the blowing fan 311 collides with the surface of the conveyance belt 321 existing in the blowing area. In this manner, the air colliding with the surface of the conveyance belt 321 travels along the surface of the conveyance belt 321 and generates the air flow F1 directed to the leading end of the sheet P entering the blowing area from the upstream side of the sheet conveyance direction as illustrated in FIG. 6. This air flow F1 floats the leading end of the sheet before the sheet P enters the blowing area, so that the leading end of the sheet is caught in a neighboring member such as an outer wall of the drying chamber 313, and the sheet P is separated from the conveyance belt 321. This may generate a conveyance failure.

In this regard, according to the present embodiment, the restriction wire 341 is also provided in a position for restricting floating of the leading end of the sheet P entering the blowing area. As a result, even when the air flow F1 described above is generated, floating of the leading end of the sheet P is restricted by the restriction wire 341 until the sheet P enters the blowing area. As a result, a conveyance failure, such as the leading end of the sheet being caught on the surrounding member such as the wall member 313d of the drying chamber 313 is reduced, and stable sheet conveyance can be obtained.

Further, in the present embodiment, the blowing region is surrounded by the wall member 313d of the drying chamber 313. The drying chamber 313 of the present embodiment has a sheet inlet 313a to receive the sheet P from the upstream side in the sheet conveyance direction into the inside of the drying chamber 313, and a sheet outlet 313b to eject the sheet P from the inside of the drying chamber 313 to the downstream side in the sheet conveyance direction. The drying chamber 313 has no openings in other portions. Therefore, the air flow F1 generated by blowing of the blowing fan 311 is easily blown out strongly from the inside of the drying chamber 313 toward the outside through the sheet inlet 313a. Therefore, the strong air flow F1 blown out from the sheet inlet 313a hits the leading end of the sheet P before entering from the sheet inlet 313a of the drying chamber 313, and the leading end of the sheet easily floats up.

For this reason, according to the present embodiment, floating of the sheet P is continuously restricted by the restriction wire 341 from the upstream side to the downstream side in the sheet conveyance direction of the sheet inlet 313a of the drying chamber 313. As a result, floating of the leading end of the sheet is continuously restricted until the leading end of the sheet P passes through the sheet inlet 313a. Therefore, even when a strong air flow F1 blows from the sheet inlet 313a, it is possible to stably suppress floating of the leading end of the sheet.

According to the present embodiment, a restriction start position where restriction of the restriction wire 341 starts, specifically, a position where the restriction wire 341 is wound around the first pulley 342 is appropriately set in a position where a flow rate of the air flow F1 blowing from the sheet inlet 313a is sufficiently reduced. As the restriction start position becomes apart from the sheet inlet 313a of the drying chamber 313 to the upstream side of the sheet conveyance direction, floating restriction of the leading end of the sheet becomes more convenient. However, the size of the drying unit 300 increases in the sheet conveyance direction disadvantageously.

In the upstream side of the sheet conveyance direction relative to the restriction start position where the floating restriction of the sheet P starts, the sheet P borne on the surface of the conveyance belt 321 is not restricted by the restriction wire 341. For this reason, the sheet P may be curled during conveyance on the transfer cylinder 202 of the image forming unit 200, or the sheet P may be wrinkled due to ink separation. As a result, the leading end of the sheet P may float in the upstream side of the sheet conveyance direction relative to the restriction start position. In this case, the floating leading end of the sheet may fail to enter a gap between the restriction wire 341 and the conveyance belt 321 and generate a conveyance failure.

In this regard, the restriction wire 341 according to the present embodiment is disposed such that a wire portion looped from the upstream-side pulley 346 placed in the upstream side of the sheet conveyance direction relative to the restriction start position to the first pulley 342 where the restriction start position is located approaches the surface of the conveyance belt 321 toward the downstream side from the upstream side of the sheet conveyance direction. As a result, when the leading end of the sheet P floats from the surface of the conveyance belt 321 in the upstream side of the sheet conveyance direction relative to the restriction start position, the leading end of the sheet comes into contact with this wire portion of the restriction wire 341 and is then guided to the restriction start position along a movement of the restriction wire 341. As a result, even when the leading end of the sheet floats from the surface of the conveyance belt 321, the leading end of the sheet P can smoothly enter the gap between the restriction wire 341 and the conveyance belt 321. Therefore, it is possible to suppress a conveyance failure.

Floating Restriction in Trailing End of Sheet

Further, in the present embodiment, even after the sheet P passes through the blowing region that is blown by the blowing fan 311, air from the blowing fan 311 hits the surface of the conveyance belt 321 existing in the blowing region. Air hitting the surface of the conveyance belt 321 travels along the surface of the conveyance belt 321 in this way. As illustrated in FIG. 6, an air flow F2 flowing toward the trailing end of the sheet P that has passed through the blowing region toward the downstream side in the sheet conveyance direction. Such an air flow F2 may cause a conveyance failure by floating the trailing end of the sheet P that has passed through the blowing region and peeling off the sheet P from the conveyance belt 321.

In this regard, according to the present embodiment, floating of the trailing end of the sheet P escaped from the blowing area is also restricted by the restriction wire 341. As a result, even when the air flow F2 is generated as described above, floating of the trailing end of the sheet P is restricted by the restriction wire 341 until the sheet P escaped from the blowing area passes through a predetermined restriction interval. Therefore, it is possible to suppress a conveyance failure that may be generated when the trailing end of the sheet floats, and the sheet P is separated from the conveyance belt 321. Therefore, it is possible to obtain stable sheet conveyability.

In the present embodiment, like the above-described blowing-off of the air flow F1 from the sheet inlet 313a, the air flow F2 generated by the blowing of the blowing fan 311 is easy to strongly blow out from the inside of the drying chamber 313 to the outside through the sheet outlet 313b. As a result, the strong air flow F2 discharged from the sheet outlet 313b collides with the trailing end of the sheet P escaped from the sheet outlet 313b of the drying chamber 313, so that the trailing end of the sheet easily floats.

According to the present embodiment, floating of the sheet P is restricted by the restriction wire 341 from the upstream side to the downstream side of the sheet conveyance direction of the sheet outlet 313b of the drying chamber 313. For this reason, before and after the trailing end of the sheet P passes through the sheet outlet 313b, floating of the trailing end of the sheet P is continuously restricted. Therefore, even when a strong air flow F2 is discharged from the sheet outlet 313b, floating of the trailing end of the sheet is stably restricted.

According to the present embodiment, a restriction end position where the floating restriction of the sheet P is terminated, specifically, a position where the restriction wire 341 is wound around the second pulley 343 is appropriately set to a position where a strength of the air flow F2 discharged from the sheet outlet 313b is sufficiently reduced. As the restriction end position becomes apart from the sheet outlet 313b of the drying chamber 313 toward the downstream side of the sheet conveyance direction, floating restriction of the trailing end of the sheet becomes more convenient. However, the size of the drying unit 300 increases in the sheet conveyance direction disadvantageously.

In the drying unit 300 according to the present embodiment, a blower such as the blowing fan 311 or a heat generator such as the heat generator 312 may not be provided as long as the drying process can be performed. Therefore, for example, the sheet delivered from the image forming unit 200 may be dried naturally while it is conveyed along the sheet conveyance path. Preferably, the blower or the heat generator is provided to dry the ink within a shorter time. The heat generator is not limited to a heat generator that generates a radiant heat such as the heat generator 312. For example, a member generating heat transmitted from the member making contact with the sheet P such as the conveyance belt 321 to the sheet P may also be employed. In addition, a heat generator for raising a temperature inside the drying chamber 313 may also be employed. In this case, the blowing fan 311 may be used to blow warm air to the sheet P.

Note that the sheet conveyance path (sheet-material conveyance path) is a trajectory for conveying a sheet when the sheet (sheet material) is appropriately conveyed. When the sheet is conveyed while it is borne on the surface of the conveyance belt 321 as in the present embodiment, the sheet conveyance path corresponds to a surface portion (looped portion) of the conveyance belt 321 on which the sheet is borne.

The blowing fan 311 of the present embodiment incorporates a heater. Settings of various parameters, such as the temperature of the heater, the air speed and air volume of the blowing fan 311, and the distance between the blowing fan 311 and the surface of the conveyance belt 321, can be changed by a controller. The setting values of various parameters are changed in accordance with, for example, the type of the sheet P, the ink adhesion amount to the sheet P, the sheet conveyance speed of the conveyance belt 321, and the like. For example, the controller may change setting values of various parameters on the basis of input information that is input by an operator through a control panel provided in the inkjet recording apparatus 1, or may change the setting values of various parameters, using data or program stored in advance in the storage device. The various parameters can be manually adjusted by an operator.

Setting of parameters, such as the output wavelength of the heat generator 312, are also changeable in accordance with the type of the sheet P, the ink adhesion amount to the sheet P, the sheet conveyance speed of the conveyance belt 321, and the like. For changing the setting of parameters, as in the case of the blowing fan 311, for example, setting values of various parameters may be changed based on input information that is input by an operator through a control panel provided in the inkjet recording apparatus, or the setting values of various parameters may be changed, using data or programs stored in the storage device. Manual adjustment can also be performed by the operator.

The drive belts 331A and 331B according to the present embodiment are disposed to abut on the surface of the conveyance belt 321 in the outside of the width direction of the sheet borne on the conveyance belt 321. However, the drive belts 331A and 331B may be disposed to abut on a part or the entirety of the end regions of the width direction of the sheet P. In this case, the end regions of the width direction of the sheet P can be pressed by the drive belts 331A and 331B onto the surface of the conveyance belt 321. Therefore, it is possible to suppress floating of the sheet P and more safely suppress the floating sheet portion from entering the heat generator 312 side of the drying device 301.

The sheet opposing portion of the restriction wire 341 according to the present embodiment is disposed to face the conveyance belt 321 in the upstream or downstream side of the sheet conveyance direction from the drying area as well as the drying area of the drying chamber 313 as described above. However, the sheet opposing portion of the restriction wire 341 may be disposed in anywhere as long as it is disposed across the sheet conveyance direction of the drying area.

All of the restriction wires 341 according to the present embodiment are not disposed in the drying chamber 313, but a part of the restriction wires 341 is disposed to pass through the outside of the drying chamber 313 as illustrated in FIGS. 2 and 3. Since the inside of the drying chamber 313 according to the present embodiment has a high temperature, the restriction wires 341 are exposed to the high temperature for a long time if all of the restriction wires 341 are disposed inside the drying chamber 313. This increases the highest temperature of the restriction wire 341 and reduces a service lifetime. According to the present embodiment, the restriction wire 341 can be cooled when it passes through the outside 2 0 of the drying chamber 313. Therefore, it is possible to lower the highest temperature of the restriction wire 341 and lengthen the service lifetime. In this case, a cooler capable of cooling the restriction wire 341 passing through the outside of the drying chamber 313 may be provided. As this cooler, an air-cooled cooling fan is preferably employed without a particular limitation. In addition, similar to the restriction wire 341, the drive belts 331A and 331B are also disposed to partially pass through the outside of the drying chamber 313. As a result, similar effects can be obtained.

Variation 1

Next, a variation of the drying unit 300 in the present embodiment (this variation will be referred to as “Variation 1”) will be described. Although the basic configuration of the Variation 1 is the same as that of the above-described embodiment, except that the belt conveyor 320 adopts a conveyance belt 325 including a suction belt instead of the conveyance belt 321. Hereinafter, differences from the above-described embodiment will be mainly described.

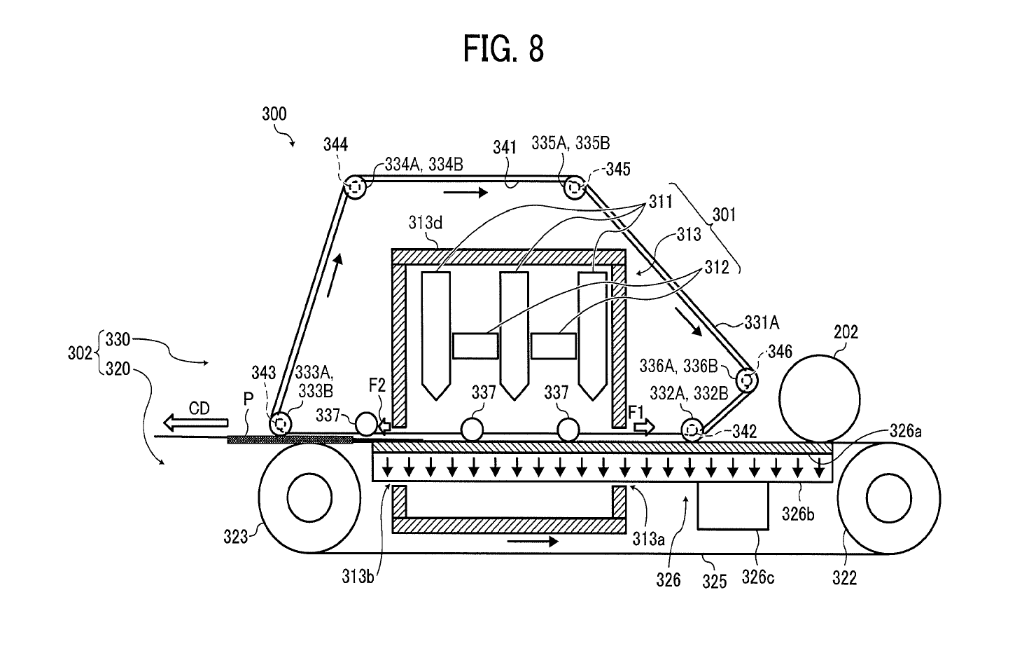

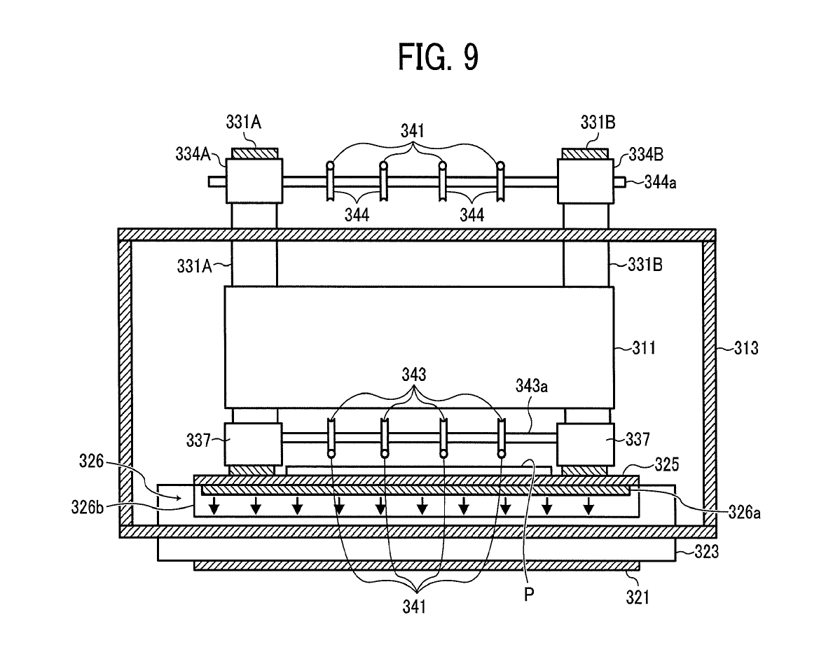

FIG. 8 is a front view of the drying unit 300 in Variation 1. FIG. 9 is a cross-sectional view when the drying unit 300 in Variation 1 is cut along a plane perpendicular to the sheet conveyance direction. The belt conveyor 320 in Variation 1 also bears the sheet P on a surface of an endless conveyance belt 325 stretched between the two support rollers 322 and 323, and conveys the sheet P along with the movement of the surface of the conveyance belt 325. The conveyance belt 325 of Variation 1 is a suction belt in which a plurality of minute through holes (suction holes) are opened in a dispersed manner on the surface thereof. A suction system 326 as a suction unit is provided on an inner circumferential face side of a belt portion (a belt portion in which the first support roller 322 moves toward the second support roller 323).

The suction system 326 includes, for example, a suction chamber 326b, and a suction device 326c to suck air in the suction chamber 326b. An upper wall portion of the suction chamber 326b is formed of a porous material 326a. When the inside of the suction chamber 326b enters a negative pressure state by the suction of the suction device 326c, a suction air flow toward the inside of the suction chamber is generated on the upper surface of the suction chamber 326b, via a plurality of pores present in the porous material 326a.

When at least one of the two support rollers 322 and 323 is driven, the conveyance belt 325 travels in the direction of the arrow in the drawing and the surface moves. At this time, due to the sucked air flow generated on the upper surface of the suction chamber 326b, the inner circumferential face of the conveyance belt 325 is attracted to the upper surface of the suction chamber 326b, and the conveyance belt 325 moves, while sliding on the upper surface of the suction chamber 326b.

In addition, due to the suction air flow generated on the upper surface of the suction chamber 326b, a suction air flow also occurs in the suction hole formed in the conveyance belt 325. As a result, the sheet P conveyed by the transfer cylinder 202 and delivered onto the surface of the conveyance belt 325 is sucked onto the surface of the conveyance belt 325 by the sucked air flow. Along with the movement of the surface of the conveyance belt 321, the sheet passes through the inside of the drying chamber 313 of the drying device 301. After that, the sheet is separated from the surface of the conveyance belt 321 and delivered to the sheet ejection unit 400.

According to Variation 1, since the sheet P is attracted onto the surface of the conveyance belt 325 by the air flow sucked by the suction system 326, the sheet P is more stably held on the surface of the conveyance belt 325 than the above-described embodiment, thus reducing floating of the sheet P.

It is not always required to form the upper wall portion of the suction chamber 326b with the porous material 326a. However, by forming the upper wall portion with the porous material 326a, even in the case of suction with a suction device 326c from one location in the suction chamber 326b, a constant suction air flow can be generated over the entire upper surface of the suction chamber 326b.

Variation 2

Next, another variation of the drying unit 300 in the present embodiment (hereinafter, this variation will be referred to as “Variation 2”) will be described. Although the basic configuration of Variation 2 is the same as the basic configuration of the above-described embodiment, except for the restriction wire 341. Hereinafter, differences from the above-described embodiment will be mainly described.

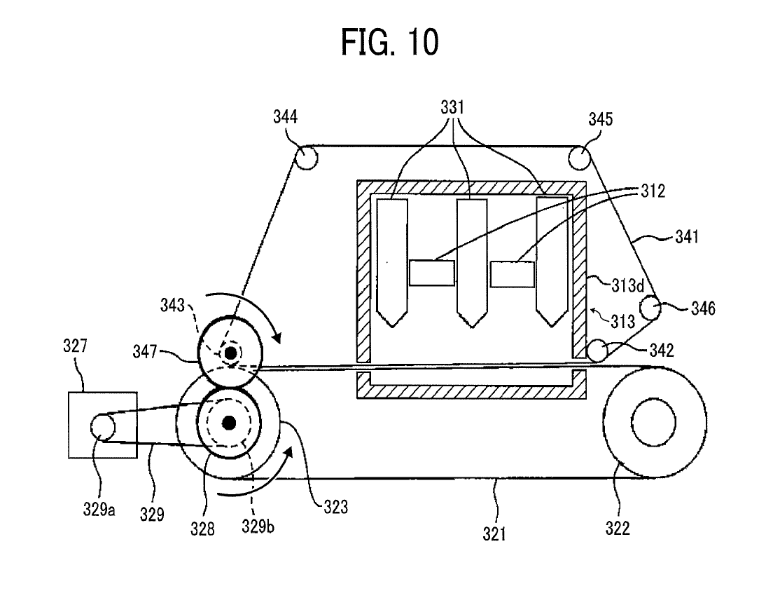

FIG. 10 is a front view of the drying unit 300 in Variation 2. In Variation 2, as the drive motor 327 is rotated, a first pulley 329a installed in the motor shaft is rotated, so that a drive transmission belt 329 looped around the first pulley 329a and the second pulley 329b is operated. The second pulley 329b is installed in the rotational shaft of the second support roller 323 where the conveyance belt 321 is looped. Therefore, as the drive transmission belt 329 is operated to rotate the second pulley 329b, the second support roller is rotated, so that the surface of the conveyance belt 321 moves.

A drive gear 328 is installed in the rotational shaft of the second support roller 323. Therefore, as the drive transmission belt 329 is operated, and the second pulley 329b is rotated, the drive gear 328 is also rotated. The drive gear 328 meshes with a driven gear 347 installed in the rotational axis of the second pulley 343 where the restriction wire 341 is looped. Therefore, as the drive motor 327 is rotated, the surface of the conveyance belt 321 moves, so that the second pulley 343 is rotated by virtue of a rotational drive force transmitted from the drive gear 328 though the driven gear 347. As a result, the sheet opposing portion of the restriction wire 341 moves to the downstream side of the sheet conveyance direction.

According to the second modification, a dedicated drive motor for the restriction wire 341 is not necessary. In addition, the sheet opposing portion of the restriction wire 341 can move at the same velocity as the velocity of the surface of the conveyance belt 321 by appropriately controlling a gear ratio between the drive gear 328 and the driven gear 347. If the sheet opposing portion of the restriction wire 341 moves at the same velocity as the velocity of the surface of the conveyance belt 321, a velocity difference between a movement velocity of the sheet opposing portion of the restriction wire 341 and a movement velocity of the image surface of the sheet borne and conveyed on the surface of the conveyance belt 321 substantially becomes zero. As a result, rubbing is not generated even when the undried ink attached on the image surface of the floating sheet portion comes into contact with the restriction wire 341, and blurring (scrape) of the undried ink (image) is suppressed.

Note that, according to the present embodiment, the conveyor for conveying the sheet is configured such that the sheet is borne on the surface of the conveyance belts 321 and 325. However, embodiments of the present disclosure are not limited to such a configuration. For example, the sheet may be borne and conveyed on a surface of a surface movable member having a drum shape such as a conveyance drum.

Variation 3

Next, still another variation of the drying unit 300 in the present embodiment (hereinafter, this variation will be referred to as “Variation 3”) will be described. In the above-described embodiment (including each of Variations 1 and 2), an example of the drying unit 300 that dries the sheet after the ink is discharged and the image is formed has been described. However, in Variation 3, a treatment in which a predetermined treatment liquid is imparted to the sheet P by application or the like in the pre-processing unit is performed, and before ink is discharged and the image is formed in the image forming unit 200, the sheet to which the treatment liquid is applied is dried in the drying unit.

The basic configuration of Variation 3 is the same as the basic configuration of the inkjet recording apparatus 1 according to the above embodiment, except that a pre-processing unit and a drying unit are added between the sheet feeding unit 100 and the image forming unit 200. The basic configuration of the added drying unit is also the same as in the above-described embodiment. Therefore, the differences from the above-described embodiment will be mainly described below.

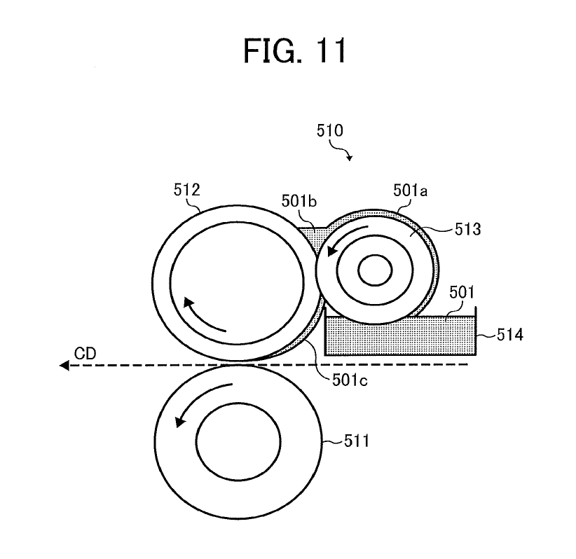

FIG. 11 is an illustration of a main part of an application device as pre-processing unit used in Variation 3. The pre-processing unit of Variation 3 includes an application device 510 that applies a treatment liquid to the sheet P fed from the sheet feeding unit 100. As the treatment liquid, for example, there is a modifying material that modifies the surface of the sheet by being applied to the surface of the sheet. Specifically, there is a fixing agent (setting agent), in which, by preliminarily applying the ink to the sheet uniformly, the moisture of the ink is quickly permeated into the sheet, the color component is thickened, and the drying is accelerated to prevent bleeding (feathering, bleeding, or the like) or strike-through, and it is possible to enhance productivity (the number of images output per unit time).

Compositionally, as the treatment liquid, for example, a solution can be used in which cellulose (for example, hydroxypropyl cellulose) which promotes penetration of moisture and a base material, such as talc fine powder, are added to surfactant (for example, one of anionic, cationic or nonionic one or a mixture of two or more of them). The treatment liquid may also contain fine particles.

The application device 510 of Variation 3 has a conveyance roller 511 to convey the sheet, an application roller 512 to apply a treatment liquid 501 to the sheet to face the conveyance roller 511, and a squeeze roller 513 to supply the treatment liquid 501 to the application roller 512 to thin the liquid film (the film of the treatment liquid 501). The direction of rotation of each roller is the direction indicated by the arrow in the drawings. In these rollers, the application roller 512 is disposed in contact with the conveyance roller 511, and the squeeze roller 513 is disposed in contact with the application roller 512.

In Variation 3, when the treatment liquid 501 is applied to the sheet by the application device 510, by the rotation of the squeeze roller 513 in the direction indicated by the arrow in the drawings, the treatment liquid 501 in the liquid tray 514 scoops up on the surface of the squeeze roller 513, is transferred in the state of the liquid film layer 501a by the rotation, and is accumulated on a valley portion (contact portion: nipping portion) between the squeeze roller 513 and the application roller 512 (treatment liquid 501b). Here, the squeeze roller 513 and the application roller 512 are in contact with each other at a constant pressing force. When the treatment liquid 501b stored in the valley portion passes between the squeeze roller 513 and the application roller 512, the treatment liquid 501b is squeezed by pressure. The liquid film layer 501c of the treatment liquid 501 is formed and is conveyed to the conveyance roller 511 side by the rotation of the application roller 512. The liquid film layer 501c transferred by the application roller 512 is applied to the sheet.

The sheet to which the liquid film layer 501c of the treatment liquid 501 is applied in this manner is conveyed to a drying unit having the same configuration as the drying unit 300 of the above embodiment (including each of Variations 1 to 3), and the drying process is performed. The sheet after being subjected to the drying process by the drying unit is fed to the image forming unit 200, and an image is formed by discharging of ink in the image forming unit 200.

The above-described embodiments are limited examples, and the present disclosure includes, for example, the following aspects having advantageous effects.

Aspect A

A conveying device, such as the conveying device 302, conveys a sheet material, such as the sheet P, along a sheet-material conveyance path, such as the sheet conveyance path. The conveying device includes a sheet-material floating restrictor, such as the restriction wire 341, disposed at a predetermined distance from a surface of the sheet material (such as the drying target surface) conveyed along the sheet-material conveyance path. The sheet-material floating restrictor includes a sheet-material opposing portion that opposes the sheet-material conveyance path. The sheet-material opposing portion is movable to a downstream side in a sheet-material conveyance direction, such as the sheet conveyance direction. According to aspect A, the sheet material opposing portion of the sheet-material floating restrictor comes into contact with a surface of a portion of the sheet material floating from the sheet-material conveyance path, so that the sheet-material floating restrictor restricts floating of the portion of the sheet material from the sheet-material conveyance path beyond the sheet-material floating restrictor. In this case, the sheet material opposing portion of the sheet-material floating restrictor moves to the downstream side of the sheet-material conveyance direction. Therefore, it is possible to reduce or remove a velocity difference between the sheet material coming into contact with the sheet material opposing portion and the sheet material opposing portion. Such a configuration can reduce rubbing between the sheet material and the sheet-material floating restrictor, thus reducing a failure that may be generated when stable conveyance of the sheet material is hindered by the contact with the sheet-material floating restrictor.

Aspect B

In the above-described aspect A, the sheet-material conveyance path has a drying area on the sheet-material conveyance path, to dry a drying target, such as ink or a treatment liquid, on a drying target surface of the sheet material. The restrictor is disposed across the drying area in the sheet-material conveyance direction, to contact a portion of the drying target surface of the sheet material floating from the sheet-material conveyance path by the predetermined distance to restrict floating of the sheet material. According to aspect B, the sheet material opposing portion of the sheet-material floating restrictor comes into contact with only a portion of the drying target surface of the sheet material floating from the sheet-material conveyance path. Such a configuration can reduce blurring generated by the contact between the undried drying target on the drying target surface of the sheet material portion and the sheet-material floating restrictor, thus reducing blurring of the drying target. In addition, as described above, the sheet material opposing portion of the sheet-material floating restrictor moves to the downstream side of the sheet-material conveyance direction. Such a configuration can reduce or remove a velocity difference between the undried drying target coming into contact with the sheet material opposing portion and the sheet material opposing portion. As a result, rubbing between the undried drying target and the sheet-material floating restrictor is suppressed. Therefore, it is possible to sufficiently suppress blurring (scrape) of the undried drying target coming into contact with the sheet-material floating restrictor.

Aspect C

In the above-described aspect B, the sheet-material floating restrictor is disposed at the predetermined distance to make a substantially point contact or a substantially line contact with a portion of the drying target surface of the sheet material. As a result, even when the sheet material opposing portion of the sheet-material floating restrictor comes into contact with the drying target surface of the sheet material portion floating from the sheet-material conveyance path, it is possible to suppress blurring of the undried drying target coming into contact with the sheet-material floating restrictor by reducing the contact area.

Aspect D

In the above-described aspects A to C, the sheet material opposing portion of the sheet-material floating restrictor includes one or more long linear members, such as the restriction wire 341, extending along the sheet-material conveyance direction. As a result, it is possible to easily implement a configuration for reducing the contact area between the surface of the sheet material portion floating from the sheet-material conveyance path and the sheet material opposing portion of the sheet-material floating restrictor.

Aspect E

In the above-described aspects A to D, the conveying device further includes a blower, such as the blowing fan 311, configured to blow air to the sheet material conveyed along the sheet-material conveyance path. In this configuration, a leading or trailing end of the sheet material easily floats by the air flow from the blower, and the floating sheet material portion easily comes into contact with the sheet-material floating restrictor. In aspect E, using such a configuration, it is possible to easily implement stable conveyance of the sheet material and suppress blurring of the undried drying target on the sheet material.

Aspect F

In the above-described aspects A to E, the conveying device further includes a heat generator, such as the heat generator 312, disposed opposite the sheet-material conveyance path with respect to the sheet-material floating restrictor. In this configuration, it is preferable to stably restrict floating of the sheet material portion coming into contact with the heat generator. In aspect F, it is possible to stably restrict floating using the sheet-material floating restrictor having such a configuration.

Aspect G

In the above-described aspects A to F, the sheet-material floating restrictor is driven such that the sheet material opposing portion moves at the same velocity as a conveyance velocity of the sheet material. As a result, it is possible to substantially remove a velocity difference between the movement velocity of the sheet material opposing portion of the sheet-material floating restrictor and the movement velocity of the conveyed sheet material opposing the sheet-material floating restrictor. As a result, rubbing is not generated even when the floating sheet material portion comes into contact with the sheet-material floating restrictor. In addition, it is possible to easily implement stable conveyance of the sheet material and suppress blurring (scrape) of the undried drying target on the sheet material.

Aspect H

In the above-described aspects A to G, the conveying device further includes a conveyor, such as the belt conveyor 320, configured to convey the sheet material with movement of a surface of a surface movable member, such as the conveyance belt 321 or 325, with a backside of the surface of the sheet material opposing the sheet-material floating restrictor being supported by the surface movable member. As a result, it is possible to stably convey the sheet material.

Aspect I

In the above-described aspect H, the surface movable member includes a suction hole to generate a suction air flow, and the conveyor conveys the sheet material attracted to the surface of the surface movable member by the suction air flow through the suction hole, with the movement of the surface of the surface movable member. As a result, it is possible to stably suppress floating of the sheet material itself.

Aspect J

In the above-described aspect H or I, the sheet-material opposing portion of the sheet-material floating restrictor is moved by the movement of the surface of the surface movable member. As a result, a dedicated drive source for driving the sheet-material floating restrictor is obviated, and the sheet material opposing portion of the sheet-material floating restrictor and the sheet material easily move at the same velocity.

Aspect K

In the above-described aspects A to J, the sheet-material floating restrictor is displaceable in a sheet-material width direction perpendicular to the sheet-material conveyance direction. As a result, it is possible to adjust a relative opposing position of the sheet-material floating restrictor against the sheet material or the number of the sheet-material floating restrictors opposing the sheet material. In addition, it is possible to position the sheet-material floating restrictor in an appropriate opposing position for the sheet materials having different width-direction sizes or position an appropriate number of sheet-material floating restrictors.

Aspect L

In the above-described aspects A to K, a drying chamber, such as the drying chamber 313, includes a wall member having at least a sheet material access port, such as the sheet inlet 313a and the sheet outlet 313b, disposed on the sheet-material conveyance path, and the sheet-material floating restrictor is an endless member, such as the restriction wire 341, disposed to pass through an outside of the drying chamber. As a result, even when the sheet-material floating restrictor is exposed to a high temperature inside the drying chamber, the sheet-material floating restrictor is cooled when the sheet-material floating restrictor passes the outside of the drying chamber. Therefore, it is possible to lower the highest temperature of the sheet-material floating restrictor and lengthen a service lifetime.

Aspect M

A printing apparatus includes a liquid discharger, such as the liquid discharge heads 220C, 220M, 220Y, and 220K, to discharge liquid, such as ink, to a sheet material, such as the sheet P, and the conveying device according to any one of the aspects A to L, such as the conveying device 302, to convey the sheet material. In aspect M, it is possible to implement a printing apparatus capable of suppressing a failure that may be generated when stable conveyance of the sheet material is hindered by the contact with the sheet-material floating restrictor.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A conveying device comprising:
a restrictor disposed at a predetermined distance from a surface of a sheet material conveyed along a sheet-material conveyance path,
the restrictor including a sheet-material opposing portion that opposes the sheet-material conveyance path,
wherein the sheet-material opposing portion is movable to a downstream side in a sheet-material conveyance direction.

2. The conveying device according to claim 1, further comprising a drying area on the sheet-material conveyance path, to dry a drying target on the sheet material, wherein the restrictor is disposed across the drying area in the sheet-material conveyance direction.

3. The conveying device according to claim 1,
wherein the restrictor has a shape of making a substantially point contact or a substantially line contact with the surface of the sheet material.

4. The conveying device according to claim 1,
wherein the sheet-material opposing portion of the restrictor includes one or more linear members extending along the sheet-material conveyance direction.

5. The conveying device according to claim 1, further comprising a blower to blow air to the sheet material conveyed along the sheet-material conveyance path.

6. The conveying device according to claim 1, further comprising a heat generator disposed opposite the sheet-material conveyance path with respect to the restrictor.

7. The conveying device according to claim 1,
wherein the restrictor is driven such that the sheet-material opposing portion moves at a same velocity as a conveyance velocity of the sheet material.

8. The conveying device according to claim 1, further comprising a conveyor to convey the sheet material with movement of a surface of a surface movable member.

9. The conveying device according to claim 8,
wherein the surface movable member includes a plurality of suction holes in a surface of the surface movable member, and
wherein the conveying device further comprises a suction unit to generate air flow in the plurality of suction holes to attract the sheet material onto the surface of the surface movable member.

10. The conveying device according to claim 8,
wherein the sheet-material opposing portion of the restrictor is moved by the movement of the surface of the surface movable member.

11. The conveying device according to claim 1,
wherein the restrictor is displaceable in a sheet-material width direction perpendicular to the sheet-material conveyance direction.

12. The conveying device according to claim 1, further comprising a drying chamber to dry a drying target on the sheet material, and
wherein the restrictor is disposed to pass from an inside of the drying chamber to an outside of the drying chamber.

13. A printing apparatus comprising:
a liquid discharger to discharge liquid to the sheet material; and
the conveying device according to claim 1 to convey the sheet material.
